(19) United States
(12) Patent Application Publication
(10) Pub. No.: US 2026/0075455 A1
(43) Pub. Date: Mar. 12, 2026

(54) DOWNLINK LINK ADAPTATION

(71) Applicant: Dell Products L.P., Round Rock, TX (US)

(72) Inventors: Jeebak Mitra, Ottawa (CA); Gwenael Poitau, Montreal (CA)

(21) Appl. No.: 18/827,170

(22) Filed: Sep. 6, 2024

(51) Int. Cl. H04W 28/02; H04L 1/1812; H04L 1/1829; H04L 5/00

(52) U.S. Cl. CPC H04W 28/0221; H04L 1/1835; H04L 5/0055; H04L 5/0057; H04L 1/1812

(57) ABSTRACT

Use of a data-driven approach that assimilates historical signal to interference-plus noise ratio (SINR) and channel estimation data along with location-map of the cell in which base station equipment is situated to better define the relationship between SINR and the user-channel environmental map and spatio-temporal changes to it to achieve more granular, cell site-specific modeling is disclosed herein. This data-driven approach estimates SINR using variational autoencoders. Variational encoders typically consist of two sections, an encoder section and decoder section. The encoder section learns the distribution on the low-dimensional latent space over the input data samples. The decoder section is a generative model that learns the joint distribution of the latent variables and input data.

### REFERENCE TO RELATED APPLICATIONS

The subject patent application is related to U.S. patent application Ser. No. ______, filed ______, and entitled “GENERATIVE MODEL FOR SINR ESTIMATION” (docket no. 139616.01/DELLP1292US) and U.S. patent application Ser. No. ______, filed ______, and entitled “COMPENSATION OF OUTDATED CQI FOR LINK ADAPTATION” (docket no. 139620.01/DELLP1293US), the entireties of which applications are hereby incorporated by reference herein.

### BACKGROUND

Communication over wireless channels can be challenging due to the time-varying nature of the channel, whereby the signal properties can vary in the frequency (phase) and time domain (amplitude). This creates uncertainty in transmission as maintaining a constant target block error rate (BLER) can become difficult due to the sporadic fluctuations.

Link adaptation (LA) can be used in wireless communication systems to optimize (e.g., maximize) data transmission rates based on current conditions extant on a communication channel. Typically, link adaptation adjusts modulation schemes and coding rates, based, for instance, on the quality of communication links, as determined by BLERs, signal-to-noise ratios (SNRs) and/or bit error rates (BERs).

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a system for downlink adaptation with automated optimization capabilities, in accordance with various non-limiting example embodiments.

FIG. 2 depicts a method, flow chart, or time sequence, for downlink adaptation with automated optimization capabilities, in accordance with various non-limiting example embodiments.

FIG. 3 illustrates another method, flow chart, or time sequence, for downlink adaptation with automated optimization capabilities, in accordance with various non-limiting example embodiments.

FIG. 4 illustrates a further method, flow chart, or time sequence, for downlink adaptation with automated optimization capabilities, in accordance with various non-limiting example embodiments.

FIG. 5 depicts a block diagram for downlink data path of a wireless base station, in accordance with various non-limiting example embodiments.

FIG. 6 illustrates inputs and outputs of a downlink adaptation module in accordance with various non-limiting example embodiments.

FIG. 7 illustrates a sequence to address outdated channel quality information (CQI) issues using deep neural networks (DNNs) within a deep reinforcement learning (DRL) based link adaptation implementation, in accordance with various non-limiting example embodiments.

FIG. 8 illustrates positive and negative reward shaping buffers based prioritized experience replay, in accordance with various non-limiting example embodiments.

FIG. 9 depicts a use case illustration of prioritized experience replay (PER) for fair learning for LA, in accordance with various non-limiting example embodiments

FIG. 10 illustrates a cloud storage systems, such as an elastic cloud storage (ECS) system, in accordance with various non-limiting example embodiments.

FIG. 11 illustrates a block diagram representing an illustrative non-limiting computing system or operating environment in which one or more aspects of various non-limiting embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

In accordance with various example embodiments, a system, apparatus, or device is provided comprising: a processor; and a memory that stores executable instructions that, when executed by the processor, facilitate performance of operations. The operations can comprise receiving, from a user equipment, channel quality indicator report data associated with a sub-band of a group of sub-bands, wherein the channel quality indicator report data is associated with a downlink channel between the base station and the user equipment, receiving, from the user equipment, hybrid automatic repeat request data comprising bit data representing acknowledgement/negative acknowledgement data for a code block of data that was transmitted to the user equipment. The operations can further comprise using a reinforcement learning model representative of a defined action space, a group of actions to be performed in the defined action space, and a collection of reward values associated with performance of an action of the group of actions within the defined action space. The operations can further comprise determining, based on the performance of the action, modulation and coding scheme data to be implemented by the user equipment and the base station equipment via the downlink channel, and transmitting the modulation and coding scheme data to the user equipment.

In some embodiments, a reporting frequency associated with the receiving of the channel quality indicator report data from the user equipment is determined by the base station equipment.

In additional embodiments, evaluation of input based on the reinforcement learning model uses a first buffer and a second buffer, where the first buffer represents actions that, when performed, are associated with positive rewards, and the second buffer represents action that, when performed, are associated with negative rewards. The positive rewards can be determined based on a maximization of at least one of a reduction in energy consumption by the base station equipment or an increase in a quality of service metric associated with the user equipment.

In further embodiments, the negative rewards are determined based on at least one of an increase in energy consumption by the base station equipment or a decrease in a quality of service metric associated with the user equipment and the positive rewards are determined based on a combination of a maximization of a reduction in energy utilization by the base station equipment and an increase in a quality of service metric associated with the user equipment. In this regard, the combination of the maximization of the reduction in energy utilization by the base station equipment and the increase in the quality of service metric associated with the user equipment is associated with a highest positive reward.

In certain embodiments, the first buffer comprises a list of a group of lists, wherein the list of the group of lists is ranked in accordance with an increasing ranking. The ranking can be determined based on at least one positive reward of the positive rewards. where an order of the group of lists is determined based on a combination of a maximization of a decrease of power usage by the based station equipment, a first minimization of a block error rate experienced by the user equipment, and a second minimization of a latency time associated with a transmission of data, via the downlink channel, between the base station equipment and the user equipment.

In accordance with further embodiments, the subject disclosure describes a method, comprising a sequence of acts that can include receiving, by network equipment comprising at least one processor from a user equipment of a group of user equipment, channel quality indicator report data associated with a sub-band of a group of sub-bands. In this regard, the channel quality indicator report data can be associated with a downlink channel between the network equipment and the user equipment. The acts can further include receiving, by the network equipment from the user equipment, hybrid automatic repeat request data comprising bit data representing acknowledgement/negative acknowledgement data for a code block of data that was transmitted to the user equipment. The acts can further include using, by the network equipment, a learning model that implements a defined action space, a group of actions to be performed in the defined action space, and a collection of reward values associated with performance of an action of the group of actions within the defined action space, based on the performance of the action. The acts can further include determining, by the network equipment, modulation and coding scheme data representative of a selected modulation and coding scheme to be implemented by the user equipment and the network equipment on the downlink channel, and transmitting, by the network equipment to the user equipment, the modulation and coding scheme data.

In example embodiments, usage of the learning model uses a first buffer and a second buffer, where the first buffer represents actions that, when performed, are associated with positive rewards, and the second buffer represents action that, when performed, are associated with negative rewards. In this regard, the positive rewards can be determined based on a maximization of one or more of reducing energy consumption by the network equipment or increasing a quality of service metric associated with the user equipment.

In further embodiments, the negative rewards are determined based on one or more of increasing energy consumption by the network equipment or decreasing a quality of service metric associated with the user equipment, and the positive rewards are determined based on maximizing a reduction in energy utilization by the network equipment and increasing a quality of service metric associated with the user equipment. The maximizing of the reduction in energy utilization by the network equipment and the increasing of the quality of service metric associated with the user equipment can be associated with a highest positive reward.

In other embodiments, the first buffer comprises a list of a group of lists, where the group of lists is ordered according to an increasing ranking, and the ordering is determined based on a positive reward of the positive rewards. A ranking of the group of lists can be determined based on one or more of maximizing a decrease in power usage by the network equipment, minimizing a block error rate experienced by the user equipment, or minimizing a latency time associated with a transmission of data, on the downlink channel, from the network equipment and the user equipment.

In regard to the above, in certain embodiments a reporting frequency associated with sending the channel quality indicator report data can be determined by the network equipment.

In accordance with still further embodiments, the subject disclosure describes a machine-readable storage medium, a computer readable storage device, or non-transitory machine-readable media comprising instructions that, in response to execution, cause a computing system comprising at least one processor to perform operations. The operations can comprise receiving, from a group of user equipment, channel quality indicator report data associated with a sub-band of a group of sub-bands, wherein the channel quality indicator report data is associated with a downlink channel between base station equipment and the group of user equipment. The operations can further comprise receiving, from the group of user equipment, hybrid automatic repeat request data comprising bit data representing acknowledgement/negative acknowledgement data for a code block of data transmitted to the group of user equipment. The operations can further comprise using a trained artificial intelligence model configured based on a defined action space, a group of actions to be performed in the defined action space, and a collection of reward values associated with performance of an action of the group of actions within the defined action space. The operations can further comprise determining, based on the performance of the action, modulation and coding scheme data to be implement by the group of user equipment and the base station equipment on the downlink channel. The operations can further comprise transmitting the modulation and coding scheme data to the group of user equipment.

In some embodiments, the trained artificial intelligence model is configured to use a first buffer and a second buffer, where the first buffer represents actions that, when performed, are associated with positive rewards, and the second buffer represents action that, when performed, are associated with negative rewards. The positive rewards can be determined based on a maximization of one or more of a reduction in energy consumption by the network equipment or an increase in a quality of service metric associated with the user equipment, and the negative rewards can be determined based on one or more of an increase in energy consumption by the network equipment or a decrease in a quality of service metric associated with the user equipment.

Maximizing user throughput is one of the primary objectives of the network optimization engines that have been adopted by mobile network operators (MNOs). An optimal resource allocation solution can be useful only if it can be determined and applied to network entities within its expected time. For contemporary wireless networks, such expected time (or real-time requirement) can be of the order of 1 ms or less. Therefore, higher layer radio access network (RAN) functions such as resource scheduling, mobility management, and radio resource management, tend to be static rule-based and are unable to adapt to the dynamics of the network or the variations in user demand that is anticipated for the various use cases for fifth generation (5G) new radio (NR) including private wireless network implementations catering to, for instance: (i) the Fourth Industrial Revolution (Industry 4.0)—an ongoing transformation in manufacturing and related industries through the adoption of digital technologies, characterized by the integration of cyber-physical systems, the Internet of Things (IoT), cloud computing; and (ii) immersive mixed-reality applications-applications that blend the physical and digital worlds to create highly interactive and engaging experiences, encompassing both augmented reality (AR), which overlays digital content onto the real world, and virtual reality (VR), which creates entirely virtual environments. Such applications demand dynamic provisioning of networks in a heretofore unprecedented manner and thus requires adding intelligence to the RAN functions to assist in the decision making process. The overall expectation is that of leading to improved user experience and more efficient network resource utilization.

Additionally, in regard to maximizing user throughput, a resource allocation solution is useful only if it can be determined and applied to the network entities within its expected time. For contemporary wireless networks, such expected time (or real-time requirement) can be of the order of 1 ms or less. Therefore, higher layer RAN functions such as resource scheduling, mobility management, and radio resource management, currently tend to be static rule-based and are unable to adapt to the dynamics of the network or variations in user demand that is anticipated for the various use cases for 5G NR implementations. Link adaptation is the functionality that is designed to select appropriate transmission parameters, e.g., the modulation and coding scheme (MCS), based on the instantaneous wireless channel to provide high transmission efficiency. However, link adaptation is only optimal if the information it receives to make such decisions are accurate. In a wireless environment various impairments and finite processing delays imply inaccuracies in obtaining channel state information either due to computational limitations or due to feedback delay. Example embodiments described as part of this disclosure help address these deficiencies in obtaining useful channel information.

The dramatic increase in cellular network traffic has meant the use of higher frequency bands and wider bandwidths for mobile communication networks. However, in lower bands (e.g., sub-6 gigahertz (GHz)), spectrum availability continues to be limited and since this continues to be the primary band generally used by commercial MNOs around the world more efficient means of network resource utilization are imperative for 5G and advanced networking implementations. Both resource allocation and energy management and wireless communication systems require accurate traffic analysis and prediction. In accordance with disclosed embodiments, by proactively estimating the future traffic load, mobile network operators can dynamically allocate network resources and can improve the spectral and energy efficiencies. Predicting cellular traffic at a fine granularity is an important but challenging endeavor due to the time varying and load-dependent behavior of traffic demand. Actual traffic demand can further be dependent on many factors, such as time of the day, day of week, special events, public holidays, and other seasonal events. Also, cellular traffic load can be location dependent, wherein traffic loads at different base station (BS) equipment can vary significantly due to user behavior and quality of service (QoS) requirements from different user applications hosted on user equipment (UE).

Further, with the increase in cellular network traffic, the use of higher frequency bands and wider bandwidths for mobile communication networks has been necessitated. However, in lower frequency bands (e.g., sub-6 GHZ), spectrum availability continues to be limited and since these lower frequency bands continue to be primary frequency bands used by mobile network operator (MNOs) around the world are a more efficient means of network resource utilization are imperative for 5G and beyond.

As mentioned above, link adaptation (LA), is a technique/process that can be used in wireless communication systems to, for example, to optimize (e.g., maximize) data transmission rates based on the current channel conditions being experienced, while using wireless communication infrastructure associated with an MNO entity, to communicate with user equipment. In general, link adaptation dynamically adjusts modulation schemes and coding rates based, for example, on the quality of communication links, as determined by signal-to-noise ratios (SNRs) and/or bit error rates (BERs).

Common modulation schemes so far have included quadrature amplitude modulation (QAM), phase shift keying (PSK), and frequency shift keying (FSK), and the like. Higher-order modulation schemes, such as 64-QAM, can transmit more bits per symbol but can also require higher SNRs (e.g., the propagated signal is much stronger in relation to noise) to maintain reliability. Coding rates can refer to adding redundancy to the transmitted data using error-correcting codes (ECC) such as convolutional codes (e.g., error-correcting codes used in digital communication systems to enhance the reliability of data transmissions-they work by adding redundant information to the transmitted data, which allows the receiver to detect and correct errors that may occur during transmission) or Turbo codes (e.g., high-performance error-correcting codes used to achieve performance approaching the theoretical maximum efficiency of a communication channel). It should be observed that higher coding rates can mean less redundancy than lower data rates. but higher coding rates can nonetheless be less robust to errors compared to lower coding rates. A code rate is generally the ratio of the number of input bits to the number of output bits—a code rate of 1/2 means that each input bit is encoded into two output bits; typical code rates are 1/2, 1/3, 2/3, and the like.

Link adaptation can potentially be designed to target any objective provided a defined or definable BLER target is not being breached. A BLER is commonly determined as being a ratio of the number of incorrectly received data blocks to the total number of transmitted blocks over a determined communication channel. A block can be considered incorrect where one or more bits within the block are erroneous, despite error correction attempts. Link adaptation in the past has used several criterion, such as throughput maximization, transmit power control, and the like have been considered as preferred objectives under the BLER constraint. For link adaptation schemes in the past, the dimensions that were explored have included adaptive modulation and coding. Adaptive modulation coding schemes are techniques and/or processes designed to enhance the efficiency and reliability of data transmissions by dynamically adjusting the modulation scheme and coding rate based on determined extant channel conditions. Adaptive modulation coding optimizes the balance between data rate and error performance.

Other dimensions that have been explored include the selection of appropriate multiple input multiple output (MIMO) pre-coding schemes. MIMO pre-coding employs techniques and/or processes that improve data transmission rates and reliability by leveraging multiple antennas at both the transmitter end and receiver end to exploit spatial diversity and spatial multiplexing. Pre-coding is generally concerned with the processing applied at the transmitter side to manage and optimize the transmitted signals, and transmit power control.

Additional dimensions that have previously been explored have included transmit power control for link adaptation. Transmit power control is a technique used to dynamically adjust the transmit power of a transmitted signal in order to optimize link performance, such that when transmit power control is combined with link adaptation strategies, for instance adaptive modulation and coding schemes, the transmit power control aspects enhance the efficiency and reliability of communications. Processes associated with transmit power control typically adjust the power level of transmitted signals to achieve desired communication performance metrics, thereby aiding in managing interference, conserving energy, and maintaining link quality. Use of link adaptation strategies in conjunction with transmit power control methodologies provides for dynamic adjustment of communication parameters (e.g., modulation schemes, coding rates) based on current channel conditions. Link adaptation can maximize throughput while ensuring reliability and minimizing error rates.

Fifth generation new radio (5G NR) is the global standard for a unified, more capable 5G wireless air interface. The key benefits of 5G NR are faster data speeds and improved capacity for mobile users; extremely low latency and high reliability; support for vastly more connected devices, such as IoT devices, with efficient, low-power connectivity; utilizes a wide range of spectrum bands, including sub-6 GHz and millimeter-wave frequencies, providing both extensive coverage and high capacity; enhances signal quality and network capacity through use of massive MIMO and beamforming; allows for the creation of multiple virtual networks on a single physical network infrastructure, each of the multiple virtual networks can be tailored to specific requirements of different applications or services; and can reduce energy consumption for both devices and network infrastructure, which can be important for sustainability and cost reduction. Additionally, 5G NR provides faster downloads and uploads, improved streaming quality, and better overall user experience; reduces latencies for applications requiring real-time feedback, such as gaming, augmented reality and visual reality, and autonomous vehicles; support for more networking equipment per cell; and provides enhanced coverage and connectivity, especially in dense urban areas and remote locations.

5G NR in implementation can add additional degrees of freedom such as: scalable numerology (e.g., a flexible framework that allows for various subcarrier spacing and slot durations to efficiently support a wide range of services with different performance requirements); bandwidth parts (e.g., allowing networking and/or networked equipment to operate on a portion of a carrier bandwidth-a frequency range over which a single carrier signal can operate through use of subcarrier spacing, slot duration, and/or adaptable flexible frame structures); and hybrid beam forming (e.g., methodologies to enhance signal quality, increase capacity, and improve spectral efficiency by combining both analog and digital beam forming methods to leverage their respective advantages and mitigate their limitations). These additional degrees of freedom have nevertheless led to a multi-dimensional link adaptation problem that can be significantly complex to adequately resolve.

While machine learning based approaches have been applied to the link adaptation problem, these approaches have required huge training data sets in order to capture a broad range of channel conditions. Moreover, many of the proposed techniques to resolve the multi-dimensional nature of the link adaptation problem have placed heavy reliance on channel quality indicators provided as feedback by UE to be faultless (e.g., the channel quality indicators supplied as feedback fail to take into consideration unaccounted delays and errors). Further, link adaptation can significantly benefit from aperiodic reporting (e.g., networking equipment sends measurement or status reports to the network on a non-regular, on-demand basis), however, despite the manifold benefits of aperiodic reporting, prior machine learning solutions, in order to keep system overhead low, have avoided using the concept of aperiodic reporting.

Networking equipment with multiple operational modes need to choose the best mode out of several possible modes of operation in order to optimize (e.g., maximize or minimize) system driven objective functions. In order to achieve this, this disclosure provides systems and/or methods that facilitate link adaptation with automated optimization capabilities, wherein transmission parameters are determined, identified, and/or selected in order to maximize the number of successfully transmitted bits per unit time within specified latency limits.

UE periodically send instantaneous channel quality indicator values to provide BS equipment responsible for servicing the UE indications of the current downlink channel quality. The UE can estimate the instantaneous signal to interference-plus noise ratio (SINR) from the radio signal in the process of removing several time varying impairments that can affect the transmitted signal, which is thereafter used to generate the instantaneous channel quality index value being a mapping function, such as:

$$CQI = ( γ ) ∈ \{ 0 , 1 , … , K \} ,$$

where φ(•) is a function that maps the SINR into a quantized channel quality information (CQI) value.

However, the CQI feedback can be inaccurate due to several factors, such as quantization errors, computation and transmission delays, as well as infrequent reporting.

Moreover, with the varying nature of 5G application scenarios, optimizing the scheduling for throughput alone only partially resolves these issues. Therefore, more versatile scheduling capabilities are needed for high performance products.

The methods and systems described herein apply in general to any orthogonal frequency division multiple access (OFDMA) system and more particularly to the downlink (DL) of cellular systems equipped with multiple antennas. OFDM is a digital modulation scheme known as orthogonal frequency division multiplexing, and is generally used in wireless communication systems, such as long-term evolution (LTE) and 5G (NR) systems, to enhance data transmission efficiency and network capacity.

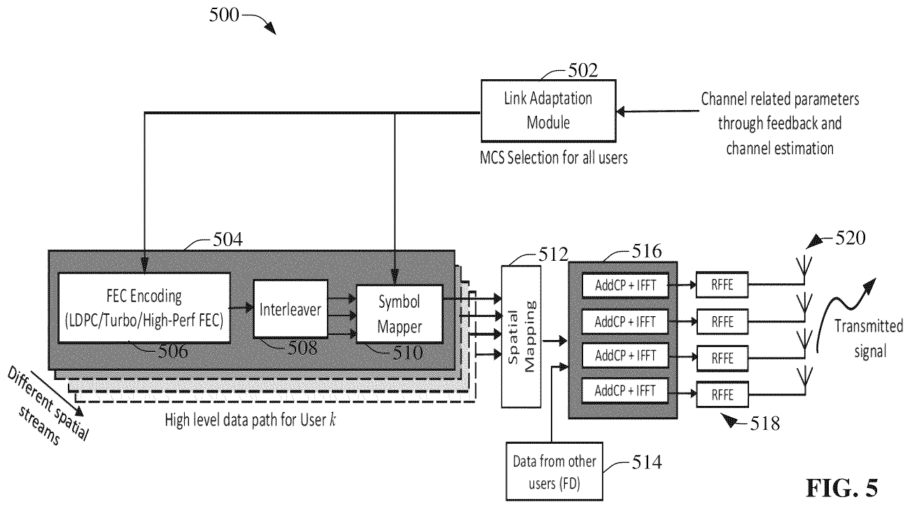

For generic multiple input multiple output orthogonal frequency division multiplexing (MIMO-OFDM) systems with Nₜₓ transmit antennas and with UE using Nᵣₓ receiver antennas the baseband processing is depicted in FIG. 5.

FIG. 5 illustrates a system 500 for down link adaptation in accordance with example embodiments. System 500, in some example embodiments, depicts a typical data and control flow of an Orthogonal Frequency Division Multiplexing-based Physical (OFDM-based PHY) layer situated at BS equipment considering four transmit antennas 520. System 500 comprises a link adaptation module 502 (e.g., adaptation engine 102) that can receive as input, from networking equipment, channel related parameter values through feedback (a) from the networking equipment, (b) from one or more UE in operative communication with the BS equipment, and/or (c) parameter values determined, based at least on the channel related parameter values, by using one or more channel estimation process (e.g., processes that enable receiver equipment to accurately detect and decode transmitted signals by compensating for the effects of the wireless channel). Link adaptation module 502 can provide distinct modulation and coding schemes (MCSs) for all equipment (e.g., UE, networking equipment. internet of things (IoT) equipment, etc.) within the broadcast purview of system 500. Link adaptation module 502 can provide individuated MCSs by determining modulation types and coding rates for data transmission for each equipment within the control purview of system 500. In providing MCSs, link adaptation module 502 can balance data rates and reliability based on channel conditions, enabling efficient and robust communication between all communication equipment within the control ambit of system 500. By adapting the MCS dynamically, system 500 can optimize performance to meet the varying demands of different applications and environments.

Once link adaptation module 502 has provided/generated a MCS for a defined UE (e.g., user k), the MCS can be transmitted to the UE via one or more different spatial streams associated with the UE, wherein each of the one or more different spatial streams can comprise a high level data path (e.g., high level data path 504) associated with the UE. Each high level path can comprise: a forward error correction (FEC) encoding component 506 that can be executable code in execution used in telecommunications and data storage to improve the reliability of data transmission and storage. The FEC encoding component 506 can generally operate by adding redundant data (error correction codes) to original data (e.g., received data) so that errors can be detected and corrected without needing to retransmit the original data. Example FEC codes that can be used by FEC encoding component 506 can comprise low-density parity-check (LDPC) error-correcting codes, Turbo codes capable of providing error correction performance close to the theoretical maximum efficiency of a communication channel (e.g., the Shannon limit), and other high-performance FEC coding schemes, such as Polar codes (e.g., an encoding scheme capable of achieving capacity-approaching performance for a wide range of channels), Reed-Solomon codes (e.g., block-based FEC encoding generally used in data transmission and storage systems), Bose-Chaudhuri-Hocquenghem codes (e.g., a class of cyclic error-correcting codes capable of correcting multiple random error patterns), etc.

Thereafter, the result of the FEC encoding component can be directed to an interleaver component 508. Interleaver component 508 can be a defined hardware device (inclusive of processors) and/or a process in execution on a generic device comprising at least one processor. Interleaver component 508 can typically be used to rearrange the order of a sequence of data in a predefined manner. The primary purpose of rearranging the order of the sequence of data is to protect the data from burst errors, which are errors that can occur in clusters and can affect consecutive bits and/or symbols in a stream of bits and/or symbols.

Additionally, each high level path 504 can also comprise a symbol mapper component 510 that converts binary data (bits) into symbols that can be transmitted over a communication channel. These symbols can be representative of complex numbers or points in a signal constellation diagram-a graphical representation of the complex symbols used in digital modulation schemes. The signal constellation diagram plots the possible signal values (constellations) on a complex plane, where the x-axis can represent an in-phase component (I) and the y-axis can represent a quadrature component (Q). Each point on the signal constellation diagram can correspond to a specific symbol that can be transmitted. It should be noted symbol mapper component 510, in some embodiments, can be referred to as being a modulator or encoder, is a crucial component in digital communication systems.

Once the symbol mapper component 510 has converted the binary data (bits) into symbols that can be transmitted over a communication channel, the transmissible symbols can be sent to spatial mapping component 512. Spatial mapping component 512, particularly spatial mapping components in multiple-input multiple-output (MIMO) systems, can distribute the transmitted signal across multiple antennas (e.g., in this example four antennas). The process of spatial mapping can enhance data transmission rates, reliability, and overall performance of wireless communication systems, such as system 500. The result of the distribution by spatial mapping component 512, together with additional data from other UE that can be operational in the frequency domain (FD) 514, can be supplied to a cyclic prefix (CP) and Inverse Fast Fourier Transform (IFFT) component 516 to mitigate inter-symbol interference (ISI) and inter-carrier interference (ICI) caused by multipath propagation and to convert signal from a frequency domain representation back into a time domain representation. A cyclic prefix can act as a buffer region that helps maintain the orthogonality of the subcarriers (e.g., an individual frequency channel used in multicarrier modulation schemes, wherein each subcarrier carries a portion of the total data stream, allowing for parallel data transmission) in an OFDM signal, ensuring robust and efficient data transmission. The IFFT is typically used to generate a time-domain signal from frequency-domain data.

The result of cyclic prefix (CP) and inverse fast Fourier transform (IFFT) component 516 can be directed to radio frequency front end (RFFE) equipment 518. Generally, RFFE equipment 518 comprises the components and circuitry that handle the radio frequency signals before they are processed by a main transceiver or baseband processing unit. The RFFE can comprise: (i) power amplifiers (e.g., RF switches) that provide the requisite gain to the signals before being transmitted; (ii) RF filters that filter out unwanted frequencies or noise from signals, ensuring that only the desired frequency components are processed; (iii) mixers that combine and/or convert signals by mixing the RF signal with a local oscillator signal (a stable, precise signal generated at a specific frequency, used to convert signals from one frequency to another through the process of mixing) to shift the frequency; and (iv) diplexers and duplexers that separate or combine different frequency bands to allow simultaneous transmission and reception or to handle multiple frequency bands.

After processing by RFFE equipment 518 has completed, the signals can be sent to antennas that can broadcast/transmit the wireless signal.

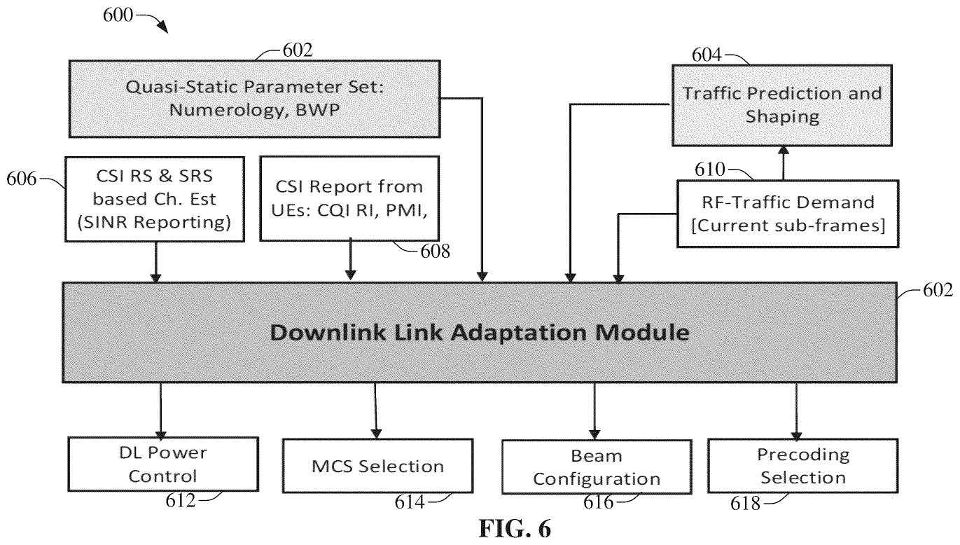

FIG. 6 provides a functional diagram 600 of downlink adaptation module 502 in accordance with many example embodiments. Downlink adaptation module 502 can receive a group of inputs that can be used to determine link adaptation policies, and output a group of outputs that can be used to configure parameters for UE within the control ambit of networking equipment, such as BS equipment. Some example input data can comprise: (a) groups of time varying parameters, values or characteristics 602 that generally change very slowly compared to the dynamic processes of interest, time varying parameters typically refer to channel characteristics that are assumed to be constant over a short period or over a certain number of transmissions but may change over longer periods; (b) traffic prediction and shaping data 604, data that can be influenced by various factors including the number of users, types of applications being used, time of day, and geographic location; (c) channel state information reference signal (CSI-RS) data and/or sounding reference signal (SRS) data 606, reference signals used in wireless communication systems, particularly in fourth generation (4G) long-term evolution (LTE) and 5G NR, and that enable efficient channel estimation, link adaptation, and network optimization; (d) channel state information (CSI) report data from a plethora of UE, channel quality information (CQI) data, rank indicator (RI) data (e.g., a measure used in MIMO systems to indicate the number of independent data streams (or layers) that can be transmitted simultaneously over the same frequency resources between a transmitter (e.g., BS equipment) and a receiver (e.g., UE), pre-coding matrix indicator (PMI) data (e.g., data that is a part of the channel state information (CSI) report data returned by UE to the BS equipment, indicative of which pre-coding matrix from a predefined codebook should be used to transmit data to the UE) 608; and (c) radio frequency traffic demand data 610—data that can also be influenced by various factors including the number of users, types of applications being used, time of day, and geographic location.

The group of parameters, values, or characteristics 602 can include values associated with: channel gain (the attenuation or amplification of signals as the propagate through a channel); path loss (the reduction in power density of a signal as it travels from transmitter to receiver); shadow fading (caused by large obstacles such as buildings and hills obstructing a signal path); Doppler shift (resulting from the relative motion between the transmitter and receiver, leading to a frequency shift in the received signal); and/or interference levels (levels of unwanted signals from other transmitters operating in the same or adjacent frequency bands).

Traffic prediction and traffic shaping are processes that improve the efficiency and reliability of data transmission in communication networks. Traffic prediction involves forecasting future network traffic patterns based on historical data, current conditions, and statistical or machine learning models. Accurate traffic prediction enables proactive network management and optimization. Traffic shaping, also known as packet shaping, is a network management technique that controls the flow of data packets to ensure efficient utilization of network resources and to meet specific performance criteria. Traffic shaping can entail delaying and/or dropping packets to regulate the data transmission rate.

CSI-RS data and SRS data 606 are two distinct data values, where CSI-RS data values are reference signal values transmitted by BS (such as gNodeB equipment in 5G or eNodeB equipment in LTE) to provide precise channel state information to UE, and SRS data values are uplink reference signal values transmitted by the UE to the BS, providing information about the uplink channel conditions.

CSI-RS data can be used by the UE to measure the channel quality, which can be reported back to the BS for link adaptation and scheduling decisions. CSI-RS data can effectuate ad/or facilitate beam forming, allowing the BS to focus the transmission beam toward the UE, thereby improving signal strength and reducing interference. In multiple-input multiple-output (MIMO) systems, CSI-RS data can be used for accurate channel estimation for multiple antennas, enabling advanced MIMO techniques.

SRS data can be used by the BS equipment to assess the quality of the uplink channel, enabling uplink link adaptation, power control, and scheduling. SRS data can also be used to effectuate and/or facilitate in uplink beam forming, allowing the BS equipment to optimize the reception beam towards the UE. Further SRS data can provide channel information for uplink MIMO and enables frequency-selective scheduling by indicating which frequency bands have better channel conditions.

Downlink adaptation module 502 in response to receiving the groups of time varying parameters, values or characteristics 602; traffic prediction and shaping data 604; CSI-RS data and/or SRS data 606; channel state information (CSI) report data 608; and/or radio frequency traffic demand data 610 can generate a group of outputs that can be used to configure parameters for various UE based on, for example, channel conditions for each user equipment, and traffic demand of each UE. As depicted in FIG. 6, the output of downlink adaptation module 502 can comprise downlink (DL) power control parameter values 612, MCS selection parameter values 614, beam configuration parameter values 616, and pre-coding selection parameter values 618.

DL power control parameter values 612 these are values that optimize network performance, enhance user experience, and efficiently use available resources. Some of the objectives attributable to DL power control are to maximize signal quality thereby ensuring that the received signal at the UE is strong enough for reliable communication without causing excessive interference, minimizing interference by reducing the power of signals in such a way that they do not interfere with neighboring cells or users, optimizing battery life by lowering power levels to reduce a UE's power consumption, thereby extending battery life, and/or adjusting power levels to use spectrum resources more efficiently and to increase the overall network capacity.

MCS selection parameter values 614 these values are selected by choosing an appropriate combination of modulation order and coding rate based on the current channel conditions. The goal of MCS selection is to maximize data throughput while maintaining an acceptable level of transmission reliability. Illustrative parameters can comprise (i) CQI values a measure reported by the UE that indicates the quality of the downlink channel, wherein higher CQI values suggests better channel conditions, allowing for higher-order modulation and higher coding rates. Conversely, a lower CQI values are indicative of poorer channel conditions, necessitating lower-order modulation and lower coding rates to ensure reliable communication; (ii) signal-to-noise ratio (SNR)/signal-to-interference-plus-noise ratio (SINR) values, a measure that provides the strength of the signal relative to the background noise and interference, wherein higher SNR/SINR values support the use of higher-order modulation schemes and higher coding rates, while lower values require more robust schemes to mitigate the effects of noise and interference; (iii) RI values that indicate the number of independent data streams that can be simultaneously transmitted over the MIMO channel, wherein higher RI values can enable the use of spatial multiplexing, increasing the data rate; (iv) PMI values that indicate an optimal pre-coding matrix for the MIMO transmission based on the channel conditions, wherein a defined pre-coding matrix can influence the effectiveness of different MCS combinations, particularly in MIMO systems; (v) CSI values can be a comprehensive set of parameters (e.g., CQI, RI, PMI) that describe the current state of the communication channel, wherein accurate and timely CSI enables better MCS selection by providing a complete picture of the channel conditions; (vi) hybrid automatic repeat request (HARQ) data generated by a HARQ protocol for error correction that combines retransmissions of data with forward error correction, wherein the outcome of HARQ feedback (success or failure) influences subsequent MCS selection, such that if previous transmissions have failed, a more robust MCS might be chosen for retransmissions; and/or (vii) feedback delay data, the delay between the UE measuring the channel and the BS receiving the feedback, wherein longer feedback delays can lead to channel information being considered outdated, necessitating more conservative MCS choices to account for potential changes in channel conditions.

Beam configuration parameter values 616 are crucial in modern wireless communication systems, particularly in technologies like LTE-Advanced and 5G NR, which utilize advanced beam-forming techniques. Beam-forming involves directing the transmission and reception of signals in specific directions to enhance signal quality, reduce interference, and increase overall system capacity. Example beam configuration parameters can comprise: beam-forming type, such as analog beam-forming that uses phase shifters to adjust the phase of the signal at each antenna element, forming a single beam, digital beam-forming that involves digital signal processing to control the amplitude and phase of the signal at each antenna element, allowing for multiple beams and more precise control, and hybrid beam-forming that combines both analog and digital techniques, balancing complexity and performance. Other beam-forming parameters can include the number of beams indicative of how many beams can be formed simultaneously. More beams can support more users or provide better coverage but require more sophisticated hardware and processing. Additional beam-forming parameters can be beam width values that refer to the angular spread of the beam-narrow beams can focus power more precisely, reducing interference and increasing gain but may require more beams to cover the same area. Beam steering range values provides a range of angles over which the beam can be steered, wider steering ranges provide more flexibility in directing the beam towards different UE or regions. Additionally, a predefined set of beam-forming vectors used to steer the beams, known as a beam-forming codebook, that can be used for beam selection and switching based on channel conditions and user locations.

Pre-coding selection parameter values 618 that can be used to transform a transmitted signal in a way that takes advantage of the spatial properties of the MIMO channel. Pre-coding selection parameters help determine the most suitable pre-coding matrix to optimize transmissions.

Channel quality reporting and SINR estimation are much more frequent acts and can possibly be performed every sub-frame based on system capability. In regard to channel quality reporting and SINR estimation, the exact periodicity of such reporting can also be limited by system capabilities, thus larger periods such as tens or hundreds of sub-frame intervals is also possible to reduce system complexity. Additionally, it should also be observed that for the output which MCS selection can potentially change every sub-frame, setting the DL power, beam configuration and pre-coding selection may not be as frequent and the triggers for these can be definable by a system design identity.

While estimating the SINR is quite important for proper link adaptation, often times it is quite difficult to do this in real-time for the entire bandwidth due to several reasons: accurate channel estimates often require matrix inversions or implementation of methods that solve them algebraically that are still computed intensive, SINR estimation for a wide-band with sparse pilots only can lead to inaccuracy in estimation for most channels except for the ideal case of frequency flat channels, and in most cases the closed formal empirical methods for SINR distribution, a popular approach to do so is to use log-normal distribution with parameters adjusted per deployment environment:

$$P ( {u}_{k} ) = {P}_{0} - 10 * {w}_{k} {log}_{10} ( \frac{{‖ {r}_{k} - {s}_{k} ‖}^{2}}{{d}_{k}} ) + {n}_{k}$$

These, however, only work for a small set of scenarios and the opportunity to derive more accurate SINRs from relevant adjacent information is missed.

A more accurate estimate might be possible by using ray tracing approaches, but these can be extremely and complex to obtain in real-time and are better suited to pre-deployment or off-line analysis.

In accordance with some embodiments, the subject disclosure proposes the use of a data-driven approach that assimilates historical SINR and channel estimation data along with location-map of the cell in which BS equipment is situated to better define the relationship between SINR and the user-channel environmental map and spatio-temporal changes to it to achieve more granular, cell site-specific modeling. This data-driven approach estimates SINR using variational autoencoders. Variational encoders typically consist of two sections, an encoder section and decoder section. The encoder section learns the distribution on the low-dimensional latent space over the input data samples. The decoder section is a generative model that learns the joint distribution of the latent variables and input data.

In various embodiments, a convolutional neural network (CNN) long term short term memory (LSTM) concatenated model can be used for SINR prediction, whereby the CNN model is used to gather the signal measurements from disparate parts of a cell based on the distribution of UE within the cell and the measured signal power for different UE located in different parts of the cell and the LSTM keeps track of the time-based correlation of the measured SINR.

A CNN is a class of deep neural networks that is particularly effective for tasks involving image and video analysis, such as image classification, object detection, and segmentation. CNNs are inspired by the human visual system and are designed to automatically and adaptively learn spatial hierarchies of features from input images. Typically a CNN comprises: (a) an input layer that receives image data, (b) one or more convolutional layers that apply groups of filters to the received image, thereby creating feature maps (e.g., small matrices that scan across the input to capture various features such as edges, textures, and patterns), (c) activation functions that apply non-linear transformations to the feature maps to introduce non-linearity into the model, a common activation function that can be used is Rectified Linear Unit (ReLU), which replaces negative values with zero, though other additional and/or alternative activation functions can also be used with equally facility and/or functionality, (d) pooling layers that can reduce the spatial dimensions (width and height) of the feature maps, this helps decrease the computational load and the number of parameters in the network, the process is known as down-sampling, (e) fully connected layers (fully connected dense layers) that can be used at the end of the network to perform classification, the fully connected layers connect every neuron in one layer to every neuron in the next layer; the output of from the last convolutional or pooling layer can be flattened into a one-dimensional (1D) vector and passed through one or more fully connected layers, and (f) an output layer that produces final predictions, through use, for example, of a softmax activation function that converts vectors of raw scores (logits) into probabilities.

In regard to a CNN's convolutional layers a convolution operation can involve sliding the filter across the input image and determining a dot product or scalar product (e.g., an operation that takes two equal-length sequences of numbers (usually coordinate vectors) and returns a single number) between the filter and the input patch with which it overlaps. Typical parameters used include filter size, stride (step size of the filter), and padding (adding zeros around the border of the input). Concerning pooling layers, there can be different types of pooling layers such as: max pooling (selects the maximum value in each patch) and average pooling (computes the average value in each patch). Further, in regard to pooling layers typical parameters can be pool size (dimension of the patch) and stride.

With regard to training a CNN an input image can be passed through the network, layer by layer, to produce the output predictions, the predictions then can be compared with the true labels using a loss function (e.g., cross-entropy loss for classification), any errors can be propagated back through the network to update the weights using, for example, gradient descent or other optimization algorithms, and network's weights can be adjusted to minimize the loss function.

A LSTM is a type of Recurrent Neural Network (RNN) designed to model temporal sequences and their long-range dependencies more accurately than conventional RNNs. LSTMs address the issue of vanishing and exploding gradients, which are common in standard RNNs, by incorporating memory cells that can maintain information over extended time periods. The key components of LSTM networks can be: (i) memory cells used to retain information over long time periods, the memory cells regulate the flow of information using gates, and (ii) gates comprising: forget gates that determine, based on a first sigmoid activation function, what information to discard from the memory cell state; input gates that determine what new information to add to the memory cell state, based on a second sigmoid function to decide which values to update, and tanh functions to create new candidate values for candidate memory cells; and output gates that control the output from memory cell states to hidden states based on which parts of the memory cell state are output, wherein hidden states are determined by applying an output gate to an updated memory cell state (e.g., determined by combining an old memory cell state and the new candidate values to update the cell state).

In regard to a cost function for joint optimization of throughput and energy efficiency through LA, it has been observed that UE can provide two critical pieces of data for downlink link adaptation (i) the channel quality indicator (CQI) report for the sub-band that it receives information on in the downlink aspect—the frequency of reporting is set by the BS, and (ii) the HARQ feedback in the form of a 1-bit acknowledgment/negative acknowledgeable (ACK/NACK) feedback for the data that is transmitted to it.

A deep reinforcement (DRL) agent for LA can be implemented at the BS equipment and in addition to CQI reports it is able to take into the fact that CQI reporting is delayed and periodic. LA processes usually ignore the CQI feedback delay or rely on the frequent CQI reporting. Both of these can cause reduction in throughput and transmission efficiency.

Typical LA strategies focus primarily on greater throughput. However, the notion of merely number of bits/sec is misleading if the block error rate (BLER) target is not met and data needs to be re-transmitted. So this disclosure provides that the throughput is determined considering that the probability of error is minimized below the BLER target. Note that due to inaccuracy in SINR estimation and CQI reports it is possible that BLER targets are sometimes breached but BLER_{avg}<BLER_{target} always holds. Furthermore, in order to minimize energy consumption, we denote by EC_{Δ}, the energy consumed by the BS equipment if transmission when using the MCS levels

$${mc}_{Δ}^{{U}_{S}}$$

for a set of users Us that are scheduled for transmission during the duration Δ, which can be expressed in multiples of TTI. Note that

$${mc}_{Δ}^{{U}_{S}} ∈ M ,$$

where M denotes the pool of MCS values defined by 3GPP for example, we can state the objective of link adaptation at time t as:

$${mc}_{t}^{u} = arg max ( {\sum }_{ι ι = 1}^{{N}_{U}} {τ}_{i n s t}^{u} + {η}_{inst} ) \qquad ( 1 )$$

where τᵢₙₛₜ is the instantaneous throughput of the u^{th} user equipment and

$${η}_{inst} = \frac{1}{E {C}_{Δ}} ,$$

and MCS selection for the u^{th} user equipment can potentially be done every TTI.

CQI reporting is generally only scheduled periodically as it can increase transmission overhead. Deciding on the periodicity of CQI can be dependent on several factors including the time varying nature of wireless channels. Generating such reports can also drain the battery life of UE especially when they are power constrained, and hence a careful trade-off needs to be made between the frequency of such reports being requested from UE versus optimization of the link parameters at the BS equipment per the most recent knowledge regarding the channel state. The reason BS equipment needs such reports to come directly from the corresponding UE is there is varied level of processing that may be done at the receiver of the UE, and the same signal to noise ratio (SNR) may be able to support different MCS levels for different UE depending on the UE's processing capability. The reported CQI thus implicitly takes into account the capability of the UE receiver data path to get rid of the effects of noise and interference. It should be noted that path loss is independent of the UE capability and is purely a function of the distance between BS equipment and UE. Nonetheless, the UE received signal also gets affected by multipath interference (MPI) and small-scale fading, both of which affect the quality of the receive signal. Most UE will have some ability to mitigate the impact of such impairments on the transmitted signal. However, since UE signal processing abilities differ based on cost, power consumption and application requirement, the ability to mitigate also varies widely. Therefore, the CQI report sent by the UE reflects a more accurate estimate of the downlink channel conditions at that instant in time.

Concerning a DRL framework for LA, since network resources and characteristics can vary with time, as well as the edge resources, classical optimization approaches can be computationally expensive, and online optimization approaches such RL can be more appropriate. Typically for RL environments deep q-networks (DQN) (policy or value based) are considered a good approach for optimization and accordingly the state space, action and rewards are defined.

Concerning states, these can be defined relatively straightforwardly through a combination of the UE uplink buffer queue and the state of the channel as captured by the estimated SINR, channel rank and HARQ Status.

With regard to actions these can be associated with LA which is pretty much determined by the MCS selection procedure and resource allocation e.g., the actual PRB allocation that determines the throughput per unit interval. However, both of these actions need to be carefully carried out as the MCS selection needs to respect the channel conditions but at the same time is lower bounded by the throughput requirements of the application, the UE's own position in the scheduling priority queue and the UE's QoS requirement.

With respect to reward shaping, typically, as an optimization objective BLER is chosen and this can be misleading in terms of training as MCS tends to be only one of the factors that determines BLER and it can be affected by other aspects that may not be entirely a function of the action taken by an RL agent for MCS. For example, if the MCS is being chosen for a HARQ re-transmission, the BLER may be improved just by virtue of the fact that the retransmission essentially combines with a previous failed transmission to enable a higher post-equalization SNR which leads to successful demodulation.

Typically, the optimization objective is the aggregate (uplink) throughput for a given bandwidth (for time division duplex (TTD), it is within the constraints of the DL:U: ratio supported by the chosen TDD pattern, however, for individual user equipment. For the k^{th} user equipment, denoting the average transmission throughput as γ^{k}, each UE can either have an individual constraint that the link parameters need to satisfy. For example, if the UE belongs to a traffic class with strict throughput and latency requirement. Alternatively, the BS may need to support a global throughput target if the UEs are not labeled for prioritized access. In such cases, the process needs to ensure that the scheduling of the UEs is not unfair to UEs that don't have the highest priority.

Enhancements to state space for the RL agent constitutes of a couple of indicators of the operating environment for the BS such as follows: (i) most recent CQI Report:

$${CQI}_{l , last}^{u}$$

denotes the latest received CQI corresponding to the sub-band ‘l’ that is to be used for scheduling. There could possibly be several transmission time intervals (TTIs) between when

$${CQI}_{last}^{u}$$

was received and the current transmission epoch ‘k’. (ii) Variational autoencoder (VAR) module based SINR (λₖ^{l}): The VAE based generated SINR can provide an estimate of the SINR for different transmission sub-bands of the DL BW. (iii) Updated CQI computation: Final considered CQI is a weighted combination of the past CQI and the CQI from the generated SINR with the weighting skewed more towards the generated SINR if a longer duration has passed e.g., reduced weighting for

$${CQI}_{last}^{u}$$

as follows:

$${CQI}_{{S}_{k}} = Quantize ( ϵ * {CQI}_{l , last}^{u} + ( i - ϵ ) * {Γ}_{u} ( {λ}_{k}^{l} ) ) \qquad ( 2 )$$

where Γᵤ(x) is a functional mapping of the SINR to the CQI that applies to the class of UE that user ‘u’ belongs to. Quantize(x), is a quantization of the CQI value x obtained from (2).

$$ϵ = \frac{1}{{2}^{k - 1}} ;$$

k-current TTI, t-TTI when CQI update was last received and sₖ denotes the current state at time k. (iv) Incorporating feedback: Since an ACK/NACK is readily provided by the UE for previously transmitted codeblocks, the MCS selection for that TTI has a realistic means of providing feedback to the RL agent regarding its actions. There is however delay in receiving such feedback,

$${Λ}_{HARQ}^{u}$$

for user u.

In order to improve RL speed the action space can be restricted by employing an adaptive ε-greedy approach. DRL agents typically perform actions from a set of valid actions A, however choosing an MCS from the 3GPP based table gives the RL agent roughly 28 options (which may increase in future). Therefore, without qualifying the actions with respect to the current state, the set of actions to explore during both training and inference stages can be too many to be useful within the time constraints for decisions. Additionally, a significant number of states would mean that guaranteeing the convergence of the RL process itself can be difficult and when multiple UEs are catered to by the BS equipment, each with BS equipment associated with its own individual RL agent for LA—there can be significant computational overhead to render the results of the RL inference useful for the UEs.

An optimal MCS process aiming at matching the time-varying wireless channel may have to switch among different MCSs frequently, wherein each switch can cause excessive signaling and system reconfiguration overheads.

It is therefore proposed that a modification to the typical RL learning flow that often uses an ε-greedy approach be made. RL approaches typically have a trade-off between exploration (with probability ε), which refers to determining the impact of various actions (given a state), vs exploitation, (with probability 1-ε), e.g., using actions that most increase an instantaneous action value so that only actions that are valid are identified.

For an MCS selection to be applied, a throughput improvement measure (TIM) value can be applied to the switching criteria, and the criteria for switching can be adapted based on the UE traffic class as follows:

$$( {mcs}_{{t}^{\text{?}}}^{u} - {mcs}_{t - 1}^{u} ) \times \frac{{T}_{m}}{{D}_{u}} > δ \qquad ( 1 )$$

$$\text{?} \text{indicates text missing or illegible when filed}$$

where

$${mcs}_{t - 1}^{u}$$

is the MCS value in use for user equipment u,

$${mcs}_{t}^{u}$$

is the MICS candidate to be selected at ‘t’ for a duration Tₘ and Dᵤ is the total data demand of user equipment u and δ is the desired improvement is throughput requirement below which an MCS change is not made. δ can be a UE traffic class dependent parameter and the condition in the above equation implies that the MCS change to

$${mcs}_{t}^{u} ,$$

is applied if (and only if) the throughput increase by using

$${mcs}_{t}^{u} ,$$

is higher than δ (in kilobits per second (Kbps) or megabits per second (Mbps) depending on the allocated bandwidth).

In order to improve RL convergence, network behavior prioritized experience replay (PER) can be effectuated. In traditional experience replay for RL, the experience samples can be uniformly sampled from an experience buffer at random regardless of their significance/relevance. Consequently, experiences with both positive rewards and negative rewards can appear with equal weighting in the training probability during each training. For LA, the reward needs to be weighed properly as an action that leads to BLER target being met (ACK received) for example, although a positive, may also be due to use of a conservative MCS value, which keeps throughput low (a negative outcome).

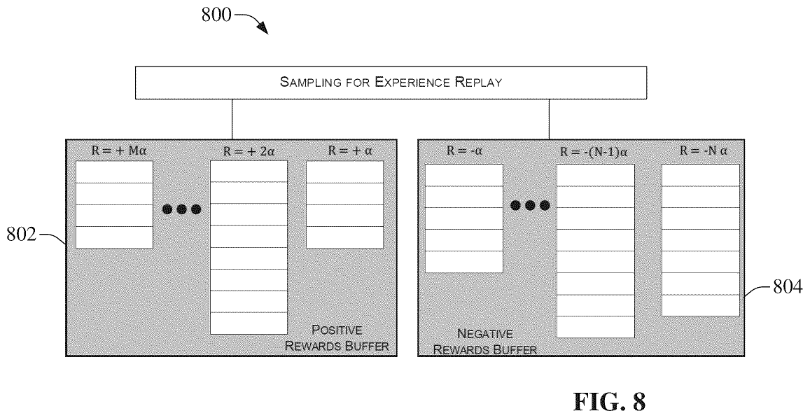

With experience stored in a replay memory, it is possible to break the temporal correlations by mixing up more and less recent experience for the updates, and rare events/experiences can be applied to more than just a single update. To achieve this a framework for prioritizing experience as it relates to link adaptation is proposed, so as to replay important network events and their impact more frequently, and therefore learn more efficiently. FIG. 8 depicts positive and negative reward shaping buffers based prioritized experience replay 800. As shown in the figure two separate buffers (e.g. positive rewards buffer 802 and negative rewards buffer 804) that record events with positive rewards and negative rewards can be used. Even within a positive (negative) buffer (e.g., 802), separate lists can be maintained with increasingly positive (negative) rewards depending on how well the optimization (e.g., maximization) objective is fulfilled and/or the number of objectives met in a multi-objective LA module. For example, throughput, latency, BLER, energy efficiency, etc. being satisfied simultaneously can be accorded the highest rewards. Also, since the training data sets are usually finite, the number of times a certain experience used for weight update of the DQN can also be varied to reduce bias.

Traditionally open loop link adaptation (OLLP) has been used to perform LA. Use of ACK/NACK feedback to refine MCS selection provides a semi real-time feedback on MCS selection and also allows for some offset adjustments depending on the LA process. However, a clear distinction can exist in the use of DRL as set forth in this disclosure vs. earlier approaches that have relied on OLLA. OLLA refines the SINR estimate(s) to the performance of each candidate MCS that is built on an offline generated SINR-MCS relationship.

The PER-DRL LA approach disclosed here essentially learns the statistical distribution for each MCS from the ACK/NACK feedback. Based on these statistical estimates, the reinforcement learning LA process predicts the optimal (e.g., maximal) MCS for data transmission in every transmission instance. Additionally, OLLA does SINR adjustments in small step sizes in response to the ACK/NACK feedback whereby the step sizes are chosen carefully offline as it determines both the convergence and stability of OLLA.

In contrast, due to the continuous learning provided by the RL agents and an explicit way to receive feedback, extensive offline fine tuning of the LA parameters is not needed and therefore the performance of the LA module doesn't require multiple SINR-MCS profile mapping to be obtained empirically a priori.

The disclosed framework in accordance with various embodiments can use two buffers that can record events with positive and negative rewards separately. Even within each of the buffers—positive and negative buffers, separate lists can be maintained with increasingly positive (negative) rewards depending on how well an optimization objective is fulfilled and/or the number of objectives met in a multi-objective LA module (e.g., adaptation engine 102), for example, throughput, latency, BLER, energy efficiency, etc. being satisfied simultaneously receives the highest reward. Moreover, since training data sets are usually finite, the number of times a certain experience is used for weight update of a Deep Q-Network (DQN)—a type of deep reinforcement learning method—can also be varied to reduce bias.

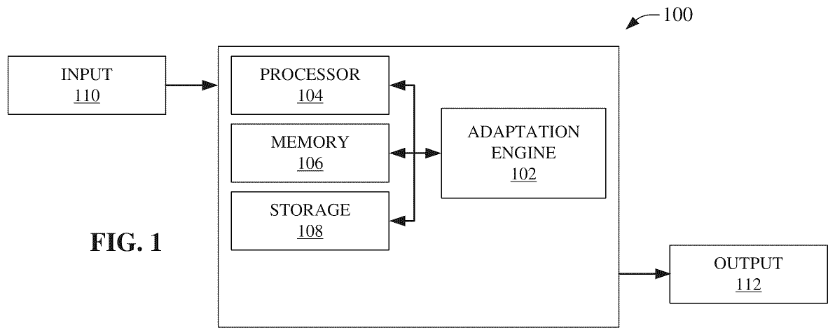

FIG. 1 depicts a system 100 for downlink adaptation with automated optimization capabilities, in accordance with various non-limiting example embodiments. System 100, for purposes of illustration, can be any type of mechanism, machine, device, facility, apparatus, and/or instrument that includes a processor and/or is capable of effective and/or operative communication with a wired and/or wireless network topology. Mechanisms, machines, apparatuses, devices, facilities, and/or instruments that can comprise system 100 can include tablet computing devices, handheld devices, server class computing equipment, machines, and/or database equipment, laptop computers, notebook computers, desktop computers, cell phones, smart phones, consumer appliances and/or instrumentation, industrial devices and/or components, hand-held devices, personal digital assistants, multimedia Internet enabled phones, Internet of Things (IOT) equipment, multimedia players, and the like.

System 100 can comprise adaptation engine 102 that can be in operative communication with processor 104, memory 106, and storage 108. Adaptation engine 102 can be in communication with processor 104 for facilitating operation of computer-executable instructions or machine-executable instructions and/or components by adaptation engine 102; memory 106 for storing data and/or computer-executable instructions and/or machine-executable instructions and/or components; and storage 108 for providing longer term storage of data and/or machine-readable instructions and/or computer-readable instructions. Additionally, system 100 can also receive input 110 for use, manipulation, and/or transformation by adaptation engine 102 to produce one or more useful, concrete, and tangible results, and/or transform one or more articles to different states or things. Further, system 100 can also generate and output the useful, concrete, and tangible result and/or the transformed one or more articles as output 112.

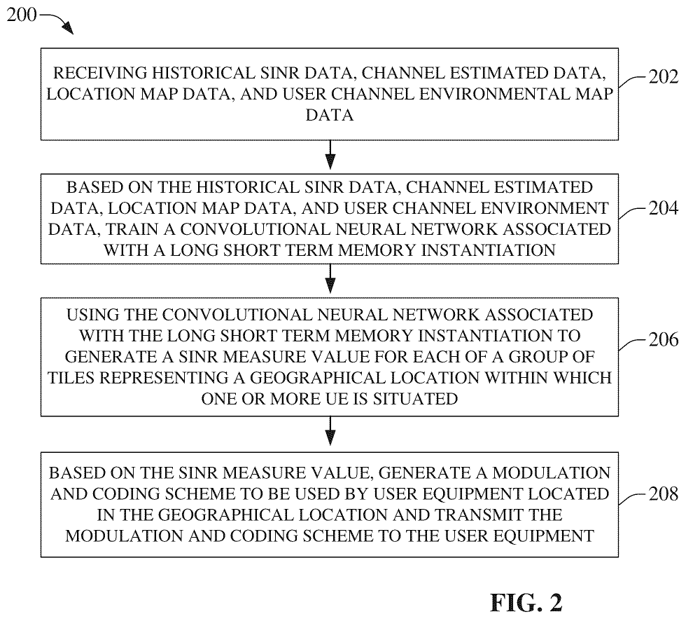

FIG. 2 illustrates a method 200 for downlink adaptation with automated optimization capabilities, wherein in some embodiments adaptation engine 102 can execute the acts detailed therein. Method 200 can commence at act 202 where adaptation engine 102 can receive historical signal-to-interference plus noise data representing an image of a cellular network infrastructure comprising sectors of a cellular structure associated with a cellular wireless network, channel estimation data representative of at least one performance metric of at least one communication channel established between BS equipment and at least one UE connected via the cellular wireless network, location map data representative of at least one location of the at least one UE, and user channel environmental map data representative of a spatio-temporal variation associated with one or more of a mobility of the at least one UE, a signal quality associated with the at least one UE, network load data associated with the cellular wireless network, and ambient environmental conditions being experienced by the at least one UE, wherein the image of the cellular wireless network infrastructure is tessellated into a group of tiles based on location map data, and wherein a first tile of the group of tiles overlaps a second tile of the group of tiles.

At act 204, based on the historical signal-to-interference plus noise data, the channel estimation data, the location map data, and the user channel environmental map data, a signal quality associated with the at least one UE, network load data associated with the cellular wireless network, and ambient environmental conditions being experienced by the at least one UE, and the group of tiles, a convolutional neural network model can be trained using a convolutional neural network associated with a long short term memory instantiation.

At act 206, adaptation engine 102, using the convolutional neural network model associated with the long short term memory instantiation, can generate a signal-to-interference plus noise ratio measurement value for each of the group of tiles based on respective distributions of respective collections of disparate UE situated within the respective sectors of the cellular wireless network infrastructure and respective measured signal powers associated with the respective collections of disparate user equipment, wherein the respective collections of the disparate user equipment are located in the respective sectors of the cellular wireless network infrastructure as tessellated into the group of tiles. Also, at act 206, adaptation engine 102 can employ an up-sampling process to increase spatial dimensions of the cellular wireless network infrastructure as tessellated into the group of tiles.

At act 208, adaptation engine 102, based on the signal-to-interference plus noise ratio measurement value, can generate a modulation and coding scheme that can be used by UE located in the geographical location and transmit the modulation and coding scheme to the UE.

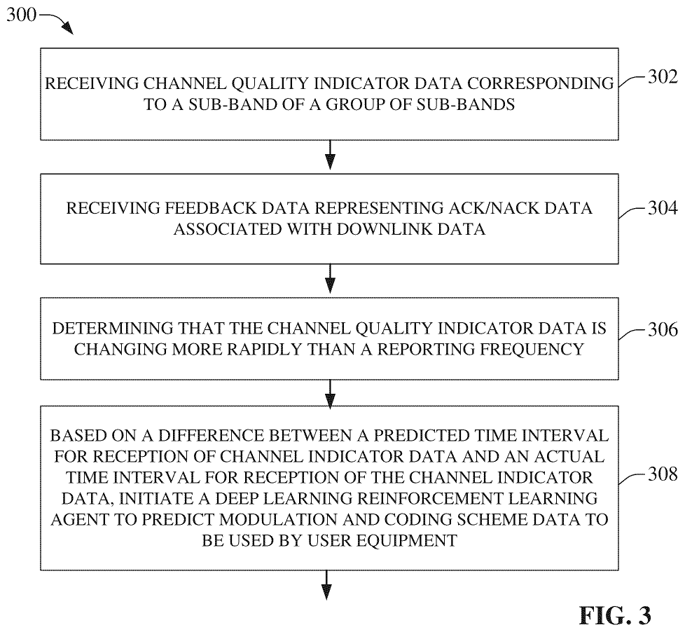

FIG. 3 illustrates another method 300 for downlink adaptation with automated optimization capabilities, wherein in embodiments adaptation engine 102 can execute the acts detailed therein. At act 302, adaptation engine 102 can receive, from UE, channel quality indicator data representative of a channel quality for a sub-band of a channel in a defined frequency spectrum, wherein the sub-band is the sub-band on which the UE receives downlink data. At act 304, adaptation engine 102 can receive, from the UE, feedback data representing acknowledgment and negative acknowledgment data associated with the downlink data transmitted to the UE. At act 306, adaptation engine 102 can determine that the channel quality indicator data is changing more frequently/rapidly than a reporting frequency specified by BS equipment for use by the UE. At act 308, adaptation engine 102, based on determining a difference between a predicted time interval for reception of channel indicator data and an actual time interval for reception of the channel indicator data, initiating a deep learning reinforcement learning agent to predict modulation and coding scheme data to be transmitted and used by the UE.

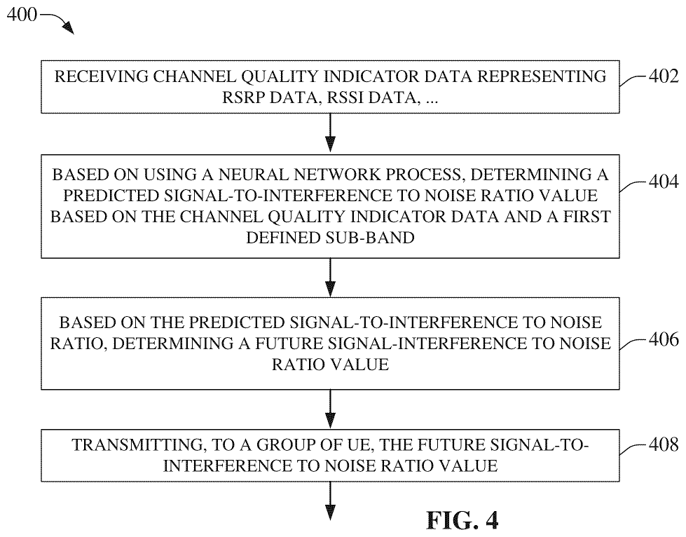

FIG. 4 illustrates a further method 400 for downlink adaptation with automated optimization capabilities, wherein in the disclosed embodiments, at act 402, adaptation engine 102 can receive channel quality indicator data representing received signal strength indicator (RSSI) data, reference signal received power (RSRP) data, and the like, wherein the channel quality indicator data is representative of a channel quality corresponding to a first defined sub-band of the group of sub-bands that is to be used in scheduling a subsequent transmission of data. At act 404, adaptation engine 102, can determine, using a neural network process, a predicted signal-to-interference plus noise ratio value based on the channel quality indicator data and a first defined sub-band.

At act 406, adaptation engine 102, based on the predicted signal-to-interference plus noise ratio value corresponding to the first defined sub-band, can determine a future signal-to-interference plus noise value to be applicable to a second defined sub-band of the group of sub-bands. At act 408, adaptation engine 102 can transmit, to a group of user equipment, the future signal-to-interference plus noise value, to be used by the group of user equipment.

RSSI data is a measure of the power level that a received radio signal has at a receiver (e.g., UE), it represents the quality and strength of the received signal. RSRP data measures the average power of a reference signal received from a single cell or sector and is used, for instance, for cell selection, handover, and coverage optimization.

In connection with channel quality indicator (CQI) data, this data can comprise a CQI value—a numerical representation of the channel quality, it typically ranges from 0 to about 15, where higher values indicate better channel quality, which can be used by BS equipment to determine the most suitable modulation scheme and coding rate for data transmission. Also, CQI data can include measurement report data measurements taken by the UE of the received signal strength and quality. These measurements can include parameters like RSRP and Reference Signal Received Quality (RSRQ). Further, CQI data can also include wideband and sub-band CQI, where the CQI can be reported as a single wideband value that reflects the overall channel quality across the entire bandwidth. Alternatively, sub-band CQI values can be reported, which provide more granular information about the channel quality in different frequency sub-bands. This allows for more precise resource allocation Further, CQI data can further include timing information about when the measurements were taken. This timing information can be important for aligning the CQI report with the current channel conditions.

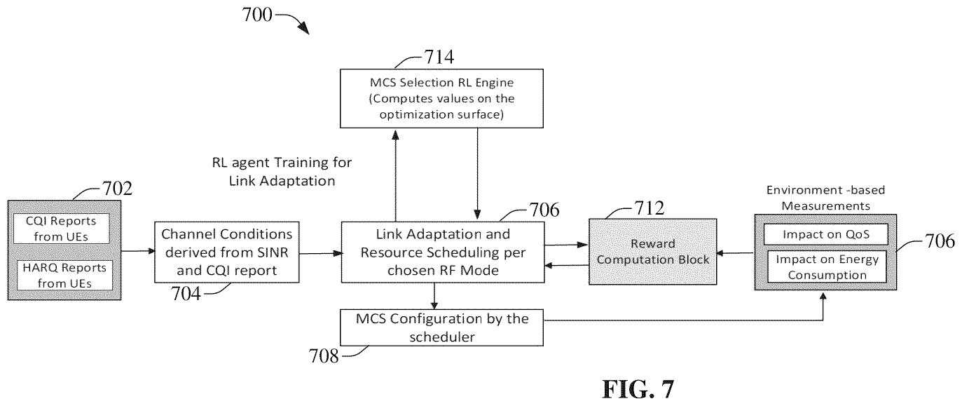

FIG. 7 illustrates another sequence 700 to address outdated CQI issues using DNNs within a DRL based link adaptation implementation. Here flow sequence 700 can commence at 702, where field generated CQI and HARQ message data (e.g., CQI reports and HARQ reports from UEs) can be directed to a link adaptation module (e.g., adaptation engine 102), wherein the link adaptation module can determine channel condition data from each of the CQI and HARQ message data at 704. The channel condition data can be determined based on SINR data and CQI data that can have been included in the received field generated CQI and HARQ message data. At 706 link adaptation and resource scheduling per chosen/determined RF mode can be identified. In connection with the link adaptation and resource scheduling at 706 input data can be received from an MCS selection RL engine can be received at 714. It will be observed in connection with the link adaptation and resource scheduling, at 706, that in addition to receiving input from the MCS selection RL engine the link adaptation and resource scheduling embodiment can also direct feedback to the MCS selection RL engine. Once link adaptation and resource scheduling per chosen/determined RF mode has been performed, at 708 a MCS configuration by a scheduling embodiment can be generated, the results of which can then be sent, at 710, to an environment based measurement aspect. The environment based measurement aspect at 710 can determine, based on the generated MCS configuration, the impact that the MCS configuration may have on quality of service (QoS) metrics and energy consumption metrics for each reporting UE. This impact data associated with QoS metrics and energy consumption metrics can then be sent, at 712, to a reward computation block that can determine reward data that should be associated with the generated MCS configuration. The reward data can then be sent to the link adaptation and resource scheduling per chosen/selected RF mode aspect.

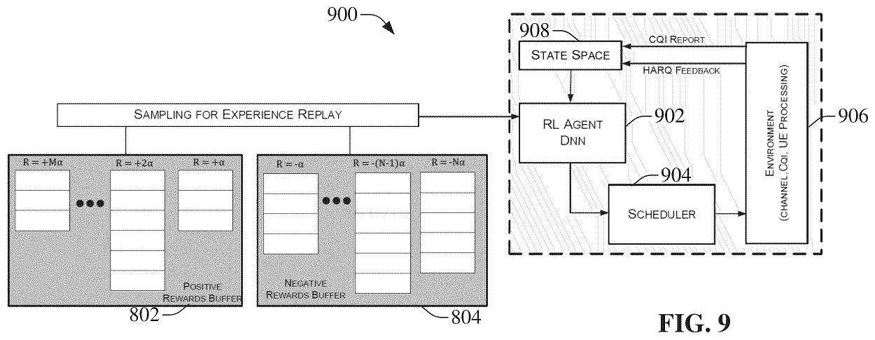

FIG. 9 provides a use case illustration of PER for fair learning for LA 900. As shown in the figure, two buffers (e.g., positive rewards buffer 802 and negative rewards buffer 804) can be used to record events with positive and negative rewards separately. During the training phase, the sample experience replay buffer feeds off of the RL agent 902 to record the outcome and assign it into the appropriate bin within the buffer (e.g., positive rewards buffer 802 and negative rewards buffer 804) as each bin can have a different weighting to be able to differentiate the usefulness or penalty of the action. In FIG. 9, α denotes a unit of the reward with +Mα being the highest positive reward and −Nα is the lowest negative reward.

Within the positive (negative) buffer (e.g., positive rewards buffer 802 and negative rewards buffer 804), the use of separate lists with increasingly positive (negative) rewards/done depending on how well the action met optimization objectives and also the number of objectives met in a multi-objective LA policy (e.g. throughput, latency, BLER, energy efficiency etc.) being satisfied simultaneously gets the highest reward. Since the training data sets are usually finite, the number of times a certain experience is used for weight update of the DQN can also be varied to reduce bias.

It will be appreciated by those skilled in the art that the preceding examples and embodiments are exemplary and not limiting to the scope of the present disclosure. It shall also be noted that elements of any claims may be arranged differently including having multiple dependencies, configurations, and combinations.

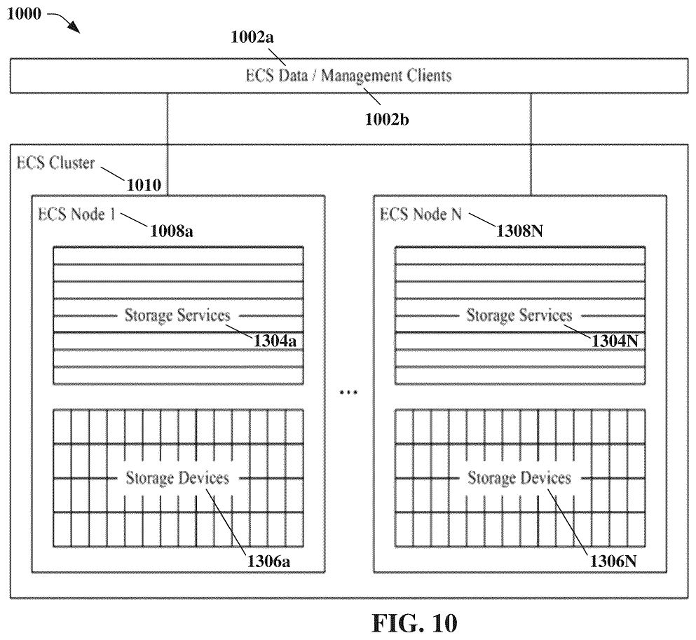

In the following, FIG. 10 describes an example non-limiting cloud storage system in the non-limiting context of an ECS storage system, but for the avoidance of doubt, the subject embodiments can apply to any storage platform. For instance, in this regard, FIG. 10 illustrates an ECS storage system 1000 comprising a cloud-based object storage appliance in which corresponding storage control software comprising, e.g., ECS data client(s) 1002a, ECS management client(s) 1002b, storage service(s) 1004a . . . 1004N, etc. and storage devices 1006a . . . 1006N (e.g., storage media, such as physical magnetic disk media, etc. of respective ECS nodes of ECS cluster 1010) are combined as an integrated system with no access to the storage media other than through the ECS storage system 1000.

In this regard, ECS cluster 1010 comprises multiple nodes 1008a . . . 1008N, storage nodes, ECS nodes, etc. Each node is associated with storage devices 1006a . . . 1006N, e.g., hard drives, physical disk drives, storage media, etc. In embodiment(s), ECS node 1008a, or any ECS node, executing on a hardware appliance can be communicatively coupled, connected, cabled to, etc., e.g., 15 to 120 storage devices. Further, each ECS node can execute one or more services for performing data storage operations described herein.

For instance, the ECS storage system 1000 can be an append-only virtual storage platform that protects content from being erased or overwritten for a specified retention period. In particular, the ECS storage system 1000 does not employ traditional data protection schemes like mirroring or parity protection. Instead, the ECS storage system 1000 utilizes erasure coding for data protection, wherein data, a portion of the data, e.g., a data chunk, is broken into fragments, and expanded and encoded with redundant data pieces and then stored across a set of different locations or storage media, e.g., across different storage nodes.

The ECS storage system 1000 can support storage, manipulation, and/or analysis of unstructured data on a massive scale on commodity hardware. As an example, the ECS storage system 1000 can support mobile, cloud, big data, and/or social networking applications. In another example, the ECS storage system 1000 can be deployed as a turnkey storage appliance, or as a software product that can be installed on a set of qualified commodity servers and disks, e.g., within a node, data storage node, etc. of a cluster, data storage cluster, etc. In this regard, the ECS storage system 1000 can comprise a cloud platform that comprises at least the following features: (i) lower cost than public clouds; (ii) unmatched combination of storage efficiency and data access; (iii) anywhere read/write access with strong consistency that simplifies application development; (iv) no single point of failure to increase availability and performance; (v) universal accessibility that eliminates storage silos and inefficient extract, transform, load (ETL)/data movement processes; etc.

In embodiment(s), the cloud-based data storage system can comprise an object storage system, e.g., a file system comprising, but not limited to comprising, a Dell EMC® Isilon file storage system. As an example, a storage engine can write all object-related data, e.g., user data, metadata, object location data, etc. to logical containers of contiguous disk space, e.g., such containers comprising a group of blocks of fixed size (e.g., 128 MB) known as chunks. Data is stored in the chunks and the chunks can be shared, e.g., one chunk can comprise data fragments of different user objects. Chunk content is modified in append-only mode, e.g., such content being protected from being erased or overwritten for a specified retention period. When a chunk becomes full enough, it is sealed, closed, etc. In this regard, content of a sealed, closed, etc. chunk is immutable, e.g., read-only, and after the chunk is closed, the storage engine performs erasure-coding on the chunk.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, the terms “logic,” “logical,” “logically,” and the like are intended to refer to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

As utilized herein, terms “component,” “system,” “engine”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server, client, etc. and the server, client, etc. can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to: random access memory (RAM); read only memory (ROM); electrically erasable programmable read only memory (EEPROM); flash memory or other memory technology (e.g., card, stick, key drive, thumb drive, smart card); solid state drive (SSD) or other solid-state storage technology; optical disk storage (e.g., compact disk (CD) read only memory (CD ROM), digital video/versatile disk (DVD), Blu-ray disc); cloud-based (e.g., Internet based) storage; magnetic storage (e.g., magnetic cassettes, magnetic tape, magnetic disk storage or other magnetic storage devices); a virtual device that emulates a storage device and/or any of the above computer-readable media; or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used to determine probabilistic likelihoods that code paths utilize operating system synchronization mechanism, as described herein.

A classifier can be a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

In accordance with various aspects of the subject specification, artificial intelligence based systems, components, etc. can employ classifiers that are explicitly trained, e.g., via a generic training data, etc. as well as implicitly trained, e.g., via observing characteristics of communication equipment, e.g., a server, etc., receiving reports from such communication equipment, receiving operator preferences, receiving historical information, receiving extrinsic information, etc. For example, support vector machines can be configured via a learning or training phase within a classifier constructor and feature selection module. Thus, the classifier(s) can be used by an artificial intelligence system to automatically learn and perform a number of functions.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As it is employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “database,” “storage medium,” “socket”, and substantially any other information storage component relevant to operation and functionality of a system, component, and/or process, can refer to “memory components,” or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in a data storage cluster, non-volatile memory 1122, disk storage 1124, and/or memory storage 1146, further description of which is below. For instance, nonvolatile memory can be included in read only memory (ROM), programmable ROM (PROM), electrically programmable ROM (EPROM), electrically erasable ROM (EEPROM), or flash memory. Volatile memory 1120 can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

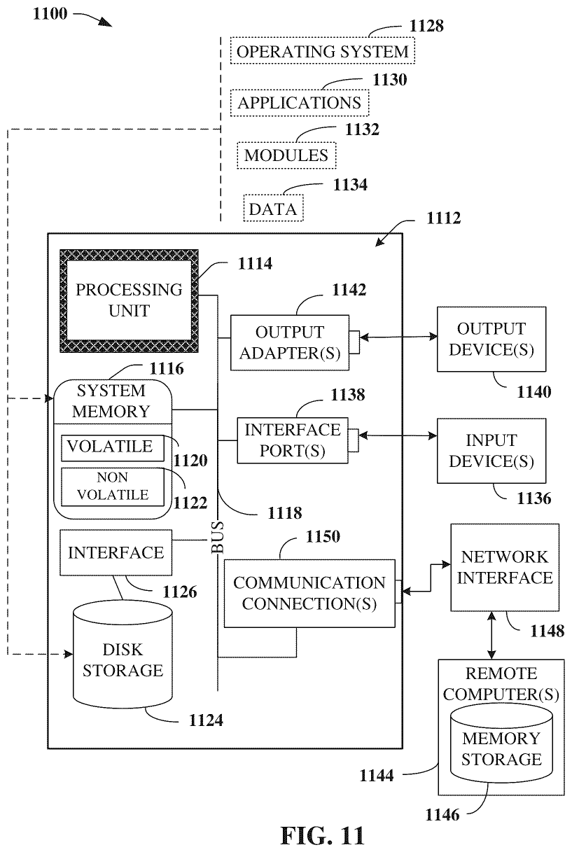

In order to provide a context for the various aspects of the disclosed subject matter, FIG. 11, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

FIG. 11, a block diagram of a computing system 1100, e.g., system 100, operable to execute the disclosed example embodiments, is illustrated, in accordance with an embodiment. Computer 1112 comprises a processing unit 1114, a system memory 1116, and a system bus 1118. System bus 1118 couples system components comprising, but not limited to, system memory 1116 to processing unit 1114. Processing unit 1114 can be any of various available processors. Dual microprocessors and other multiprocessor architectures also can be employed as processing unit 1114.

System bus 1118 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1116 comprises volatile memory 1120 and nonvolatile memory 1122. A basic input/output system (BIOS), containing routines to transfer information between elements within computer 1112, such as during start-up, can be stored in nonvolatile memory 1122. By way of illustration, and not limitation, nonvolatile memory 1122 can comprise ROM, PROM, EPROM, EEPROM, or flash memory. Volatile memory 1120 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 also comprises removable/non-removable, volatile/non-volatile computer storage media. FIG. 11 illustrates, for example, disk storage 1124. Disk storage 1124 comprises, but is not limited to, devices like a magnetic disk drive, floppy disk drive, tape drive, Jaz drive, Zip drive, LS-100 drive, flash memory card, or memory stick. In addition, disk storage 1124 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to system bus 1118, a removable or non-removable interface is typically used, such as interface 1126.

It is to be appreciated that FIG. 11 describes software that acts as an intermediary between users and computer resources described in suitable operating environment 1100. Such software comprises an operating system 1128. Operating system 1128, which can be stored on disk storage 1124, acts to control and allocate resources of computer system 1112. System applications 1130 take advantage of the management of resources by operating system 1128 through program modules 1132 and program data 1134 stored either in system memory 1116 or on disk storage 1124. It is to be appreciated that the disclosed subject matter can be implemented with various operating systems or combinations of operating systems.

A user can enter commands or information into computer 1112 through input device(s) 1136. Input devices 1136 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1114 through system bus 1118 via interface port(s) 1138. Interface port(s) 1138 comprise, for example, a serial port, a parallel port, a game port, a universal serial bus (USB), a wireless based port, e.g., Wi-Fi, Bluetooth, etc. Output device(s) 1140 use some of the same type of ports as input device(s) 1136.

Thus, for example, a USB port can be used to provide input to computer 1112 and to output information from computer 1112 to an output device 1140. Output adapter 1142 is provided to illustrate that there are some output devices 1140, like display devices, light projection devices, monitors, speakers, and printers, among other output devices 1140, which use special adapters. Output adapters 1142 comprise, by way of illustration and not limitation, video and sound devices, cards, etc. that provide means of connection between output device 1140 and system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. Remote computer(s) 1144 can be a personal computer, a server, a router, a network PC, a workstation, a microprocessor based appliance, a peer device, or other common network node and the like, and typically comprises many or all of the elements described relative to computer 1112.

For purposes of brevity, only a memory storage device 1146 is illustrated with remote computer(s) 1144. Remote computer(s) 1144 is logically connected to computer 1112 through a network interface 1148 and then physically and/or wirelessly connected via communication connection 1150. Network interface 1148 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1150 refer(s) to hardware/software employed to connect network interface 1148 to bus 1118. While communication connection 1150 is shown for illustrative clarity inside computer 1112, it can also be external to computer 1112. The hardware/software for connection to network interface 1148 can comprise, for example, internal and external technologies such as modems, comprising regular telephone grade modems, cable modems and DSL modems, wireless modems, ISDN adapters, and Ethernet cards.

The computer 1112 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1112 can connect to other devices/networks by way of antenna, port, network interface adaptor, wireless access point, modem, and/or the like.

The computer 1112 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at a 10 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating there from. Therefore, the disclosed subject matter should not be limited to any single embodiment described herein, but rather should be construed in breadth and scope in accordance with the appended claims below.

What is claimed is:

1. Base station equipment, comprising:
at least one processor; and
at least one memory that stores executable instructions that, when executed by the at least one processor, facilitate performance of operations, comprising:
receiving, from a user equipment, channel quality indicator report data associated with a sub-band of a group of sub-bands, wherein the channel quality indicator report data is associated with a downlink channel between the base station and the user equipment;
receiving, from the user equipment, hybrid automatic repeat request data comprising bit data representing acknowledgement/negative acknowledgement data for a code block of data that was transmitted to the user equipment;
using a reinforcement learning model representative of a defined action space, a group of actions to be performed in the defined action space, and a collection of reward values associated with performance of an action of the group of actions within the defined action space;
determining, based on the performance of the action, modulation and coding scheme data to be implemented by the user equipment and the base station equipment via the downlink channel; and
transmitting the modulation and coding scheme data to the user equipment.

2. The base station equipment of claim 1, wherein a reporting frequency associated with the receiving of the channel quality indicator report data from the user equipment is determined by the base station equipment.

3. The base station equipment of claim 1, wherein evaluation of input based on the reinforcement learning model uses a first buffer and a second buffer, and wherein the first buffer represents actions that, when performed, are associated with positive rewards, and the second buffer represents action that, when performed, are associated with negative rewards.

4. The base station equipment of claim 3, wherein the positive rewards are determined based on a maximization of at least one of a reduction in energy consumption by the base station equipment or an increase in a quality of service metric associated with the user equipment.

5. The base station equipment of claim 3, wherein the negative rewards are determined based on at least one of an increase in energy consumption by the base station equipment or a decrease in a quality of service metric associated with the user equipment.

6. The base station equipment of claim 3, wherein the positive rewards are determined based on a combination of a maximization of a reduction in energy utilization by the base station equipment and an increase in a quality of service metric associated with the user equipment, and wherein the combination of the maximization of the reduction in energy utilization by the base station equipment and the increase in the quality of service metric associated with the user equipment is associated with a highest positive reward.

7. The base station equipment of claim 3, wherein the first buffer comprises a list of a group of lists, wherein the list of the group of lists is ranked in accordance with an increasing ranking, and wherein the ranking is determined based on at least one positive reward of the positive rewards.

8. The base station equipment of claim 7, wherein an order of the group of lists is determined based on a combination of a maximization of a decrease of power usage by the based station equipment, a first minimization of a block error rate experienced by the user equipment, and a second minimization of a latency time associated with a transmission of data, via the downlink channel, between the base station equipment and the user equipment.

9. A method, comprising:
receiving, by network equipment comprising at least one processor from a user equipment of a group of user equipment, channel quality indicator report data associated with a sub-band of a group of sub-bands, wherein the channel quality indicator report data is associated with a downlink channel between the network equipment and the user equipment;
receiving, by the network equipment from the user equipment, hybrid automatic repeat request data comprising bit data representing acknowledgement/negative acknowledgement data for a code block of data that was transmitted to the user equipment;
using, by the network equipment, a learning model that implements a defined action space, a group of actions to be performed in the defined action space, and a collection of reward values associated with performance of an action of the group of actions within the defined action space;
based on the performance of the action, determining, by the network equipment, modulation and coding scheme data representative of a selected modulation and coding scheme to be implemented by the user equipment and the network equipment on the downlink channel; and
transmitting, by the network equipment to the user equipment, the modulation and coding scheme data.

10. The method of claim 9, wherein a reporting frequency associated with sending the channel quality indicator report data is determined by the network equipment.

11. The method of claim 9, wherein usage of the learning model uses a first buffer and a second buffer, wherein the first buffer represents actions that, when performed, are associated with positive rewards, and the second buffer represents action that, when performed, are associated with negative rewards.

12. The method of claim 11, wherein the positive rewards are determined based on a maximization of one or more of reducing energy consumption by the network equipment or increasing a quality of service metric associated with the user equipment.

13. The method of claim 11, wherein the negative rewards are determined based on one or more of increasing energy consumption by the network equipment or decreasing a quality of service metric associated with the user equipment.

14. The method of claim 11, wherein the positive rewards are determined based on maximizing a reduction in energy utilization by the network equipment and increasing a quality of service metric associated with the user equipment, and wherein the maximizing of the reduction in energy utilization by the network equipment and the increasing of the quality of service metric associated with the user equipment are associated with a highest positive reward.

15. The method of claim 11, wherein the first buffer comprises a list of a group of lists, wherein the group of lists is ordered according to an increasing ranking, and wherein the ordering is determined based on a positive reward of the positive rewards.

16. The method of claim 15, wherein a ranking of the group of lists is determined based on one or more of maximizing a decrease in power usage by the network equipment, minimizing a block error rate experienced by the user equipment, or minimizing a latency time associated with a transmission of data, on the downlink channel, from the network equipment and the user equipment.

17. A non-transitory machine-readable medium, comprising executable instructions that, when executed by at least one processor, facilitate performance of operations, comprising:
receiving, from a group of user equipment, channel quality indicator report data associated with a sub-band of a group of sub-bands, wherein the channel quality indicator report data is associated with a downlink channel between base station equipment and the group of user equipment;
receiving, from the group of user equipment, hybrid automatic repeat request data comprising bit data representing acknowledgement/negative acknowledgement data for a code block of data transmitted to the group of user equipment;
using a trained artificial intelligence model configured based on a defined action space, a group of actions to be performed in the defined action space, and a collection of reward values associated with performance of an action of the group of actions within the defined action space;
determining, based on the performance of the action, modulation and coding scheme data to be implement by the group of user equipment and the base station equipment on the downlink channel; and
transmitting the modulation and coding scheme data to the group of user equipment.

18. The non-transitory machine-readable medium of claim 17, wherein the trained artificial intelligence model is configured to use a first buffer and a second buffer, wherein the first buffer represents actions that, when performed, are associated with positive rewards, and wherein the second buffer represents action that, when performed, are associated with negative rewards.

19. The non-transitory machine-readable medium of claim 18, wherein the positive rewards are determined based on a maximization of one or more of a reduction in energy consumption by the network equipment or an increase in a quality of service metric associated with the user equipment.

20. The non-transitory machine-readable medium of claim 18, wherein the negative rewards are determined based on one or more of an increase in energy consumption by the network equipment or a decrease in a quality of service metric associated with the user equipment.
